(19) United States
(12) Patent Application Publication
(10) Pub. No.: US 2008/0173193 A1
(43) Pub. Date: Jul. 24, 2008

(54) Method of advertising

(76) Inventor: Alan Wolan, New York, NY (US)

Correspondence Address: Mark P. Stone, 4th Floor, 25 Third Street, Stamford, CT, 06905, US

(21) Appl. No.: 11/655,691

(22) Filed: Jan. 19, 2007

(51) Int. Cl. B41M 1/12

(52) U.S. Cl. 101/129

(57) ABSTRACT

A stencil displaying a pre-selected image or message is placed upon an unclean surface. The area within the stencil is washed to create a contrast with the area of the unclean surface outside of the stencil. The contrast between the cleaned area within the stencil and the uncleaned area outside the stencil creates a visually perceptible, non-permanent, display of the image or message of the stencil on the surface to which the stencil has been applied.

### BACKGROUND OF THE INVENTION

The present invention is directed to a method of displaying a preselected image or message, including advertisements, on an unclean surface, and in particular a sidewalk.

In the past, sidewalks and other publicly accessible structure, including fences and outer walls of residential and commercial buildings, have been defaced by graffiti painted permanently on the structures and sidewalks. Removal of the paint or other permanent marking materials applied to the surfaces is difficult and costly.

It is the primary object of the present invention to provide a method for applying non-permanent, preselected indicia, displays and other messages, including advertising materials, which are readily removable from the surfaces on which they are applied.

Other objects and advantages of the present invention will become apparent from the following description thereof.

### SUMMARY OF THE INVENTION

The present invention is directed to a method of displaying a pre-selected image or message, including advertising, on an unclean surface, such as a sidewalk, fence, or outer surface of a residential or commercial building structure. The stencil or template bearing the image to be displayed is placed on the unclean surface and the area within the stencil is cleaned. The stencil is then removed so that the preselected image or message is displayed as a result of the visual contrast between the cleaned area within the stencil and the surrounding uncleaned area of the surface on which the stencil was applied. Because the image or message is applied by cleaning a portion of a surface on which it is applied, the image or message does not permanently deface that surface, but on the contrary, actually cleans the portion of the surface defined by the applied image or message.

### DESCRIPTION OF THE BEST MODES FOR CARRYING OUT THE INVENTION

In accordance with the present invention, a preselected image or message, including advertising material, is non-permanently applied to an unclean or partially clean surface. Such surfaces include public and private sidewalks, fences, and outer surfaces of residential and commercial building structures.

In the first step of the method, a stencil or other template having a cut-out portion defining the preselected image or message to be displayed, is placed directly upon a predetermined surface on which the message or image is to be reproduced. The cut-out area within the stencil defining the image or message to be reproduced is then cleaned, preferably by power washing with pressurized water or other cleaning solvent, to remove dirt and stains from the surface exposed by the cut-out portion of the stencil. Known cleaning methods other than power washing can also be employed in the invention. The stencil is then removed from the surface to which it was applied.

When the stencil is removed from the surface, the image or message defined by the stencil is reproduced on the surface as a result of the visual contrast between the cleaned area of the surface as a result of the stencil, and the immediately adjacent unclean area of the surrounding surface. Thus, the image or message is readily visually perceptible by persons or passersby in the immediate area.

The method in accordance with the present invention provides means for displaying advertisements on surfaces such as sidewalks, fences, and outer surfaces of building structures, in a manner which is both quick and inexpensive. Moreover, although the images and messages are not permanently reproduced on the surfaces to which they are applied, they will remain visible to the public for a limited time, namely, until the surface cleaned by the stencil again becomes dirty, thereby eliminating the contrast between the cleaned and dirty surface areas. If desired, the image or message can be removed immediately by cleaning the surface area adjacent the image or message so as to eliminate the contrast between the cleaned and dirty surface areas.

The method in accordance with the present invention does not permanently deface the surface to which the message or image is applied, in contrast to applying paint to these surfaces. Moreover, the messages and images displayed on the surfaces in accordance with the present invention are easily removable and will, in fact, be removed automatically once the clean area again becomes dirty or stained even if no positive steps are taken to remove the image or message. In contrast, images or messages painted on surfaces, or materials such as posters which are applied to surfaces by glue, nails or staples, are more difficult and costly to remove. Moreover, the method in accordance with the present invention, in addition to non-permanently displaying an image or message, has a separate and independent incidental beneficial effect—it cleans the area of the surface on which the image or message is displayed.

Other advantages of the methods in accordance with the present invention will become apparent to those skilled in the art. Accordingly, the description of the embodiment herein is intended to be illustrative only, and not restrictive of the scope of the invention, that scope being defined by the following claims and all equivalents thereto.

1. A method of reproducing a preselected display on an unclean surface, the steps of said method comprising:
placing a stencil having a cut-out area defining said preselected display on said unclean surface,
cleaning the cut-out area within said stencil, and
removing the stencil from said unclean surface to create a visual contrast between the cut-out area within said stencil, and the area outside of the cut-out area within said stencil for non-permanently reproducing said preselected display on said unclean surface.

2. The method as claimed in claim 1, wherein the step of cleaning the cut-out area within said stencil includes the step of power washing the cut-out area within said stencil with water.

3. The method as claimed in claim 1, wherein the step of cleaning the cut-out area within said stencil includes the step of applying a cleaning solution within the cut-out area of said stencil.

4. The method as claimed in claim 1, wherein the step of placing a stencil on said unclean surface includes the step of placing said stencil on a sidewalk.

5. The method as claimed in claim 1, wherein the step of placing a stencil on said unclean surface includes the step of placing said stencil on a wall.

6. The method as claimed in claim 1, wherein the step of placing a stencil on said unclean surface includes the step of placing said stencil on a fence.

7. A method of non-permanently reproducing a preselected display on an unclean surface, the steps of said method comprising:
placing a guide having an area defining said preselected display on said unclean surface;
cleaning the area within the guide, and
removing the guide from said unclean surface to create a visual contrast between the cleaned area within said guide, and the area outside said guide for non-permanently reproducing said preselected display on said unclean surface.

8. The method as claimed in claim 7, wherein the step of cleaning the area within said guide includes the step of power washing the area within said guide with water.

9. The method as claimed in claim 7, wherein the step of cleaning the area within said guide includes the step of applying a cleaning solution in the area within said guide.

10. The method as claimed in claim 7, wherein the step of placing a guide on said unclean surface includes the step of placing said guide on a sidewalk.

11. The method as claimed in claim 7, wherein the step of placing a guide on said unclean-surface includes the step of placing said guide on a wall.

12. The method as claimed in claim 7, wherein the step of placing a guide on said unclean surface includes the step of placing said guide on a fence.

13. A method of advertising, the steps of said method comprising:
non-permanently reproducing a preselected advertisement on an unclean surface by:
placing a guide defining said preselected advertisement on said unclean surface;
cleaning an area within said guide defining said preselected advertisement; and
removing the guide from said unclean surface to create a visual contrast between the cleaned area within the guide and an area outside the guide for non-permanently reproducing said preselected advertisement on said unclean surface.

14. The method as claimed in claim 13, wherein the step of non-permanently reproducing a preselected advertisement includes the step of non-permanently reproducing a preselected written message or image.

15. The method as claimed in claim 13, wherein the step of placing a guide on said unclean surface includes the step of placing a stencil defining said preselected advertisement on said unclean surface.

16. The method as claimed in claim 13, wherein the step of cleaning an area within said guide includes the step of power washing said area within said guide with water.

17. The method as claimed in claim 13, wherein the step of cleaning an area within said guide includes the step of applying a cleaning solution to said area within said guide.

18. The method as claimed in claim 13, wherein the step of placing a guide on said unclean surface includes the step of placing said guide on a sidewalk.

19. The method as claimed in claim 13, wherein the step of placing a guide on said unclean surface includes the step of placing said guide on a wall.

20. The method as claimed in claim 13, wherein the step of placing a guide on said unclean surface includes the step of placing said guide on a fence.
